(19) United States
(12) Patent Application Publication
(10) Pub. No.: US 2004/0111549 A1
(43) Pub. Date: Jun. 10, 2004

(54) Method, system, and program for improved interrupt processing

(75) Inventors: Patrick L. Connor, Portland, OR (US); Linden Minnick, Portland, OR (US); Eric K. Mann, Hillsboro, OR (US)

Correspondence Address: David Victor, Esq., Ste. 210, 315 South Beverly Dr., Beverly Hills, CA, 90212, US

(73) Assignee: Intel Corporation

(21) Appl. No.: 10/315,610

(22) Filed: Dec. 10, 2002

(51) Int. Cl. G06F 13/24

(52) U.S. Cl. 710/260

(57) ABSTRACT

Disclosed is a method, system, and program for processing an interrupt. A new interrupt is received. It is determined whether a previous interrupt was correctly claimed. If the previous interrupt was correctly claimed, it is determined whether to claim the new interrupt without determining whether an associated interrupting device generated the new interrupt.

### BACKGROUND OF THE INVENTION

1. Field of the Invention

The present invention relates to a method, system, and program for improved interrupt processing.

2. Description of the Related Art

In computer systems, devices (e.g., components) are coupled to each other via one or more buses. A variety of devices (e.g., an interrupt controller, an I/O controller, and a device driver) can be coupled to a bus, thereby providing intercommunication between all of the various devices. An example of a bus that is used to connect devices is the peripheral component interconnect (PCI) bus.

Computer systems are designed to support the devices. These devices require intermittent servicing by a host central processing unit (CPU) in order to ensure proper operation. Services may include data transmission, data capture and/or any other data manipulative operations. The host CPU services the devices while running one or more background programs.

In some systems, a device submits an interrupt to an interrupt controller that can interrupt the host CPU, forcing a branch of the host CPU's current program to a special interrupt service routine (ISR). Interrupts may be used by devices, such as an I/O controller, for various reasons. An interrupt generally indicates that some critical or unexpected event has occurred. For example, an I/O controller may use interrupts to signal that a data packet has arrived from the network. Because data packets do not necessarily arrive at a regular rate and can be latency sensitive, interrupts are useful for handling this type of event. In particular, connection-oriented network protocols, such as Transmission Control Protocol/Internet Protocol (TCP/IP) networks, are sensitive to changes in latency, and any increase in latency results in a corresponding drop in throughput.

Under certain operating systems (e.g., a Windows® operating system), when an interrupt event occurs at a device (e.g., a data packet is received at the device), the device asserts an interrupt (e.g., an interrupt signal on a PCI bus) to an interrupt controller. The interrupt controller asserts an interrupt signal to a host central processing unit (CPU). If more than one CPU is present, the interrupt controller may have some flexibility as to which CPU is to be interrupted by the interrupt signal.

The interrupted CPU stops executing code that it is currently executing and queries the interrupt controller for the source of the interrupt, which is identified as an “interrupt vector.” An interrupt vector includes, for example, an address of interrupt code to be executed. The CPU then begins to run an operating system (OS) interrupt service routine (ISR) associated with the particular interrupt signal. For each device interrupt service routine (ISR) registered on that particular interrupt vector, the operating system ISR calls into each device ISR until one of the device ISRs claims the interrupt or until each of the device ISRs has been called, without any one claiming the interrupt.

To determine whether an associated device (e.g., an I/O controller) actually generated an interrupt, the device ISR may read a status register from the device hardware. If the device generated the interrupt, then the device ISR acknowledges the interrupt from the device and disables the device's interrupt generation ability to prevent the device from generating further interrupts until interrupt processing is complete. The device ISR then claims the interrupt from the operating system ISR. When a device ISR claims an interrupt, an interrupt handling function (e.g., a deferred procedure call (DPC)) is scheduled to occur some time later to perform the actual interrupt event processing (e.g., indicating a received packet to a protocol stack).

If the device did not generate the interrupt, the device ISR does not claim the interrupt, and implicitly, the operating system ISR calls the next device ISR for which the device may have generated the interrupt. If no device ISRs claim the interrupt, the operating system may discard the interrupt and classify the interrupt as “spurious.”

When a device is disabled from generating interrupts, the device stops signaling interrupts to the interrupt controller. The device is enabled to generate interrupts once the interrupt is processed (e.g., after an interrupt handling function completes).

With the interrupt claimed, the operating system ISR re-enables the host CPU to resume executing code previously interrupted. If other interrupts are pending at the interrupt controller, the interrupt controller keeps an interrupt signal asserted to the host CPU. If an interrupt signal is still asserted to the host CPU from the interrupt controller, the just-resumed host CPU will immediately be interrupted again, and the interrupt process is repeated.

PCI interrupts are “level triggered,” meaning that a device continues to assert the interrupt signal until the interrupt signal is acknowledged. So, in shared interrupt environments, such as a PCI environment, multiple devices can assert interrupts on a shared interrupt line. If multiple devices do in fact assert the shared interrupt line simultaneously, the chain of device ISRs are executed as many times as the number of devices interrupting. Each device ISR identifies whether or not an associated device asserted each particular interrupt. Each device ISR disables an associated device from interrupting again until the claimed interrupt has been handled. In many cases, the device is disabled from generating interrupts after the interrupt is claimed.

In summary, if a device asserts an interrupt, a device ISR reads a device register or registers to determine whether an associated device was a source of the interrupt. The device ISR writes a device register or registers to disable (i.e., mask) additional interrupts from the device. Then, the device ISR writes to a device register to acknowledge the interrupt and schedule a deferred interrupt handling routine to complete servicing of the cause of the interrupt (e.g., process a received data packet). Once the interrupt is processed, the device ISR enables interrupt generation by the device.

The execution time of the device ISR is dominated by reading a device register or registers to determine whether an associated device was a source of the interrupt because the host CPU stops other processing and waits for the device access (i.e., the access of a status register) to complete through a chipset to the device before the host CPU can continue. On some Intel chipsets, each device register read may take 600-800 nanoseconds (nsecs).

This is very inefficient, and, therefore, there is a need for improved interrupt processing.

### BRIEF DESCRIPTION OF THE DRAWINGS

Referring now to the drawings in which like reference numbers represent corresponding parts throughout:

FIG. 1 illustrates a computing environment in which aspects of the invention may be implemented.

FIG. 2 illustrates a format of a data packet in accordance with certain embodiments of the invention.

FIG. 3 illustrates logic implemented for processing of an interrupt in accordance with certain embodiments of the invention.

FIG. 4 illustrates components of a computer processing an interrupt in accordance with certain embodiments of the invention.

FIG. 5 illustrates logic implemented in a processing device ISR to process an interrupt in accordance with certain embodiments of the invention.

FIG. 6 illustrates logic implemented in a processing device ISR to process an interrupt in accordance with certain alternative embodiments of the invention.

FIG. 7 illustrates logic implemented in a processing device ISR to process an interrupt in accordance with certain alternative embodiments of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

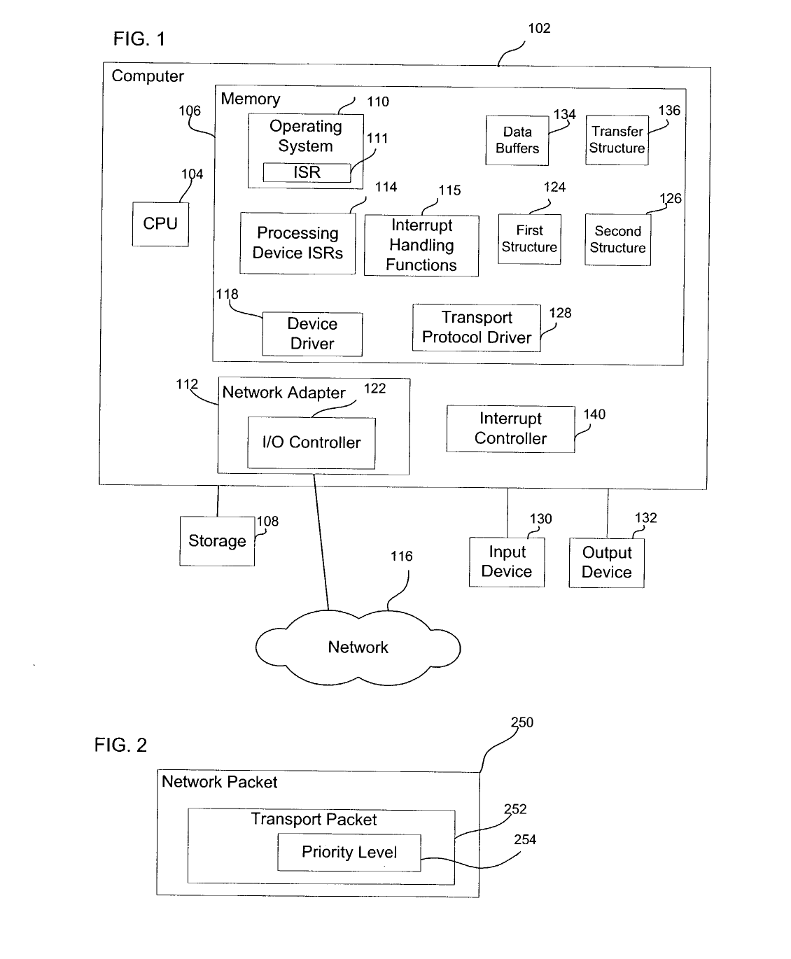

FIG. 1 illustrates a computing environment in which aspects of the invention may be implemented. A computer 102 includes a central processing unit (CPU) 104, a volatile memory 106, non-volatile storage 108 (e.g., magnetic disk drives, optical disk drives, a tape drive, etc.), an operating system 110, and a network adapter 112. The computer 102 may comprise any computing device known in the art, such as a mainframe, server, personal computer, workstation, laptop, handheld computer, telephony device, network appliance, vitalization device, storage controller, etc.

Any CPU 104 and operating system 110 known in the art may be used. The network adapter 112 includes a network protocol for implementing the physical communication layer to send and receive network packets to and from remote devices over a network 116. The network adapter 112 includes an I/O controller 122. In certain embodiments, the I/O controller 122 may comprise an Ethernet Media Access Controller (MAC) or network interface card (NIC), and it is understood that other types of network controllers, I/O controllers such as small computer system interface (SCSI controllers), or cards may be used. The term “Ethernet” is a reference to a standard for transmission of data packets maintained by the Institute of Electrical and Electronics Engineers (EEE) and one version of the Ethernet standard is IEEE std. 802.3, published Mar. 8, 2002.

The network 116 may comprise a Local Area Network (LAN), the Internet, a Wide Area Network (WAN), Storage Area Network (SAN), etc. In certain embodiments, the network adapter 112 may implement the Ethernet protocol, token ring protocol, Fibre Channel protocol, Infiniband, Serial Advanced Technology Attachment (SATA), parallel SCSI, serial attached SCSI cable, etc., or any other network communication protocol known in the art.

The storage 108 may comprise an internal storage device or an attached or network accessible storage. Programs in the storage 108 are loaded into the memory 106 and executed by the CPU 104. An input device 130 is used to provide user input to the CPU 104, and may include a keyboard, mouse, pen-stylus, microphone, touch sensitive display screen, or any other activation or input mechanism known in the art. An output device 132 is capable of rendering information transferred from the CPU 104, or other component, such as a display monitor, printer, storage, etc.

A device driver 118 includes network adapter 112 specific operations to communicate with the network adapter 112 and interface between the operating system 110 and the network adapter 112. In particular, the device driver 118 controls operation of the I/O controller 122 and performs other operations related to the reading of data packets from memory 106. The device driver 118 may be software that is executed by CPU 104 in memory 106.

In addition to the device driver 118, the computer 102 may include other drivers, such as a transport protocol driver 128. The transport protocol driver 128 executes in memory 106 and processes the content of messages included in the packets received at the network adapter 112 that are wrapped in a transport layer, such as TCP and/or IP, Internet Small Computer System Interface (iSCSI), Fibre Channel SCSI, parallel SCSI transport, or any other transport layer protocol known in the art.

In certain embodiments, the device driver 118 issues operations (e.g., writes descriptors) to the I/O controller 122. Although an operation may be any type of information, command, etc., for examples described herein, the term “transfer operation” will be used to refer to an operation that provides information about data for transfer (e.g., across an Ethernet LAN). Other operations (e.g., a storage operation that is used to store data into a structure) fall within the scope of the invention. An I/O controller 122 maintains one or more structures (e.g., a first structure 124 (e.g., a queue) and a second structure 126 (e.g., a queue)) for storing the transfer operations. In certain embodiments, the device driver 118 issues transfer operations to the I/O controller 122 and places the transfer operations in one or more of the structures 124, 126. The transfer operations identify data packets stored in one or more data buffers 134. The I/O controller 122 processes the transfer operations in structures 124, 126 to transfer data packets from data buffers 134 to a transfer structure 136 (e.g., a First In First Out (FIFO) queue) for transfer over, for example, network 116.

A device that submits an interrupt will be referred to herein as an “interrupting device” for ease of reference, while a device that processes the cause of the interrupt (e.g., processes a data packet whose receipt caused the interrupt) will be referred to herein as a “processing device” for ease of reference. An interrupting device is associated with a processing device.

An interrupt controller 140 receives interrupts from an interrupting device and asserts the interrupt to the CPU 104. The operating system 110 includes an operating system interrupt service routine (ISR) 111, which is invoked by the CPU 104 upon receipt of an interrupt.

Processing device interrupt service routines (ISRs) 114 execute in memory 106. Each processing device ISR is associated with (i.e., executes for) a processing device that processes the cause of an interrupt. Although the processing device ISRs 114 are depicted as a unit for ease of reference, the processing device ISRs 114 may be part of the software code of associated processing devices or may be separate pieces of software code. When the operating system ISR 111 attempts to determine the source of an interrupt, the operating system ISR 114 may call one or more processing device ISRs 114. Each processing device ISR 114 determines whether an associated interrupting device issued the interrupt. If so, the processing device ISR 114 claims the interrupt and may also schedule interrupt handling functions 115. Although the interrupt handling functions 115 are depicted as a unit for ease of reference, the interrupt handling functions 115 may be part of the software code of processing device ISRs 114 or may be separate pieces of software code.

Several of the devices of FIG. 1 may be directly or indirectly coupled to a bus (not shown). For instance, the device driver 118 and the I/O controller 122 may be coupled to the bus.

Although structures/buffers 124, 126, 132, and 134 are illustrated as residing in memory 106, it is to be understood that some or all of these structures/buffers may be located in a storage unit separate from the memory 106 in certain embodiments.

FIG. 2 illustrates a format of a data packet 250 in accordance with certain embodiments of the invention. The network packet 250 is implemented in a format understood by the network protocol 14, such as an Ethernet packet that would include additional Ethernet components, such as a header and error checking code (not shown). A transport packet 252 is included in the network packet 250. The transport packet may 252 comprise a transport layer capable of being processed by the I/O controller 22, such as the TCP and/or IP protocol, Internet Small Computer System Interface (iSCSI) protocol, Fibre Channel SCSI, parallel SCSI transport, etc. The transport packet 252 includes a priority level 254 as well as other transport layer fields, such as payload data, a header, and an error checking code. The payload data 252 includes the underlying content being transferred, e.g., operations, status and/or data. The operating system may include a device layer, such as a SCSI driver (not shown), to process the content of the payload data and access any status, operations and/or data therein.

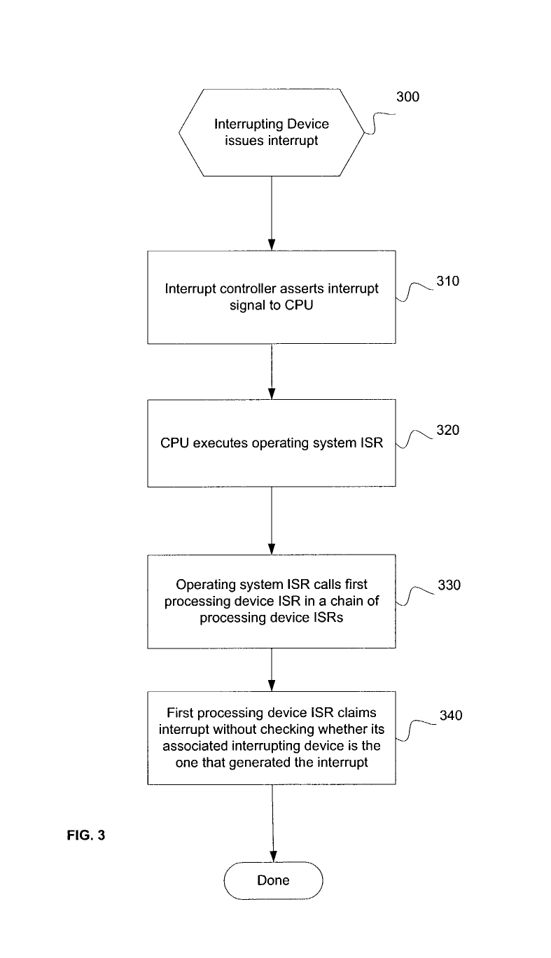

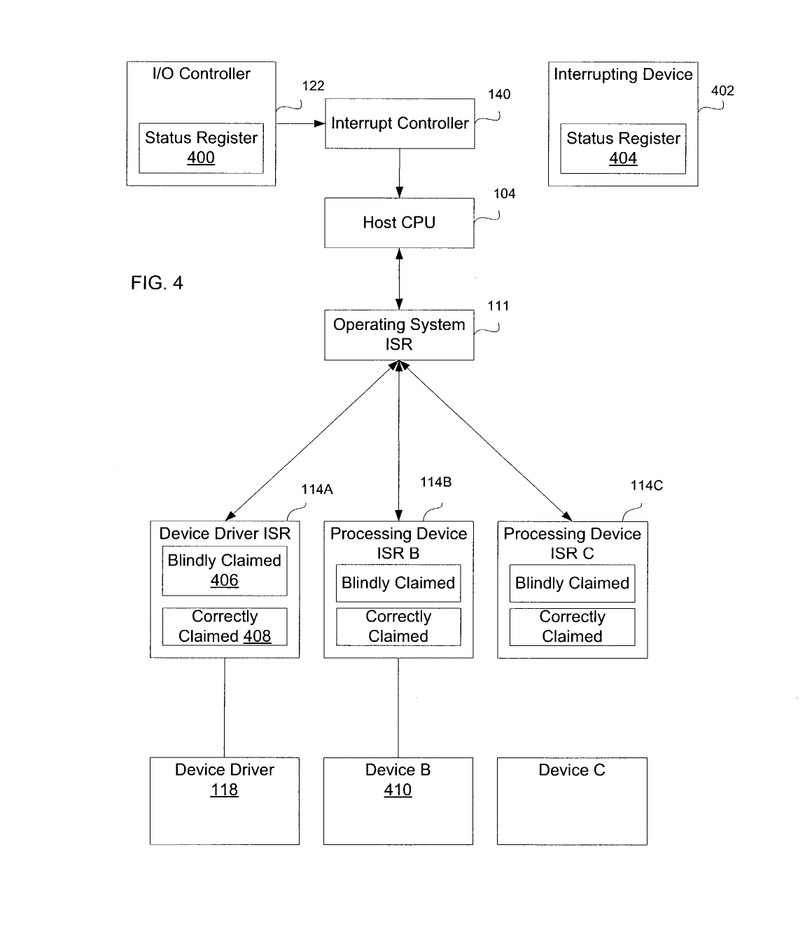

FIG. 3 illustrates logic implemented for processing of an interrupt in accordance with certain embodiments of the invention. FIG. 4 illustrates components of a computer 102 processing an interrupt in accordance with certain embodiments of the invention. In FIG. 3, control begins at block 300 with an interrupting device 410 (e.g., I/O controller 122) issuing an interrupt to an interrupt controller 140. One or more interrupting devices 122, 402 may issue interrupts to the interrupt controller 140. Examples of interrupting devices include I/O devices such as keyboards, input mice, disk controllers, serial and parallel ports to printers, scanners, network controllers, modems, and display devices. In block 310, the interrupt controller 140 asserts an interrupt signal to the CPU 104. In block 320, the CPU 104 executes an operating system ISR 111. In certain embodiments, there may be multiple operating system ISRs, and the CPU 140 executes an operating system ISR that is associated with the asserted interrupt signal.

In block 330, the operating system ISR 111 calls the first processing device ISR in a “chain of processing device ISRs.” The term “chain of processing device ISRs” is used herein to refer to a set of processing device ISRs that are called by an operating system ISR 111 with an interrupt that is to be claimed. For example, in FIG. 3, processing device ISRs 114A, 114B, and 114C form a chain. In certain embodiments, the particular processing device ISRs called depend on the interrupt. In this example, the operating system ISR 111 calls device driver ISR 114A. Device driver ISR 114A is a processing device that is associated with the I/O controller 122, which is an interrupting device.

Each interrupting device 122, 402 provides an indication of whether that interrupting device generated an interrupt. In certain embodiments, each interrupting device 122, 402 has a status register 400, 404 that may be checked to determine whether the interrupting device 122, 402 generated a particular interrupt. However, in embodiments of the invention, these status registers 400, 404 are not checked by the processing device ISRs 114A, 114B, 114C for each interrupt.

In block 340, the first processing device ISR called (e.g., device driver ISR 114A) claims the interrupt without determining whether an associated interrupting device (e.g., I/O controller 122) generated that interrupt (e.g., without checking the status register 400 of I/O controller 122). Alternatively, in block 330, the operating system ISR may call multiple processing device ISRs 114A, 114B, 114C simultaneously, and (in block 340) each processing device ISR may claim the interrupt without determining whether an associated interrupting device generated that interrupt.

In shared interrupt environments, when multiple interrupting devices assert interrupts on a shared interrupt line, multiple processing device ISRs may claim the same interrupt. In this case, the operating system ISR 111, instead of consecutively calling each processing device ISR in a chain, simultaneously calls all of the processing device ISRs in the chain. With embodiments of the invention, one or more processing device ISRs selectively claim an interrupt without determining whether an associated interrupting device is the source of an interrupt (e.g., selectively do not check a device status register to determine whether the interrupting device's hardware generated the interrupt). Determining whether an associated interrupting device is the source of an interrupt represents a large amount of time spent by the processing device ISRs and increases processing latency. By reducing the number of times the determination is made, embodiments of the invention reduce the number of interrupting device accesses (i.e., I/O accesses) that occur in the processing device ISRS.

When the operating system ISR 111 consecutively calls each processing device ISR 114, if a first processing device ISR repeatedly, blindly claimed all interrupts, then it is possible that the other processing device ISRs in a chain would not be able to claim and process their associated interrupting device interrupts. For example, if interrupting device 400 were associated with processing device 410, and an interrupt was generated by the interrupting device 402 for processing device 410 (FIG. 4), and device driver ISR 114A claimed the interrupt, then processing device ISR 114B for processing device 410 would not be able to claim and process the interrupt. Therefore, one or more of the following techniques are implemented to avoid having one processing device ISR prevent other processing device ISRs from claiming interrupts: (1) if a previous blindly claimed interrupt was incorrectly claimed, then, for the next interrupt, the processing device ISR determines whether an associated interrupting device generated that interrupt before determining whether to claim the interrupt; (2) consecutive blind interrupt claiming by a processing device ISR does not exceed a first threshold; and/or (3) the frequency of blind interrupt claiming by a processing device ISR is decreased when the processing device ISR consistently blindly, incorrectly claims interrupts exceeding a second threshold.

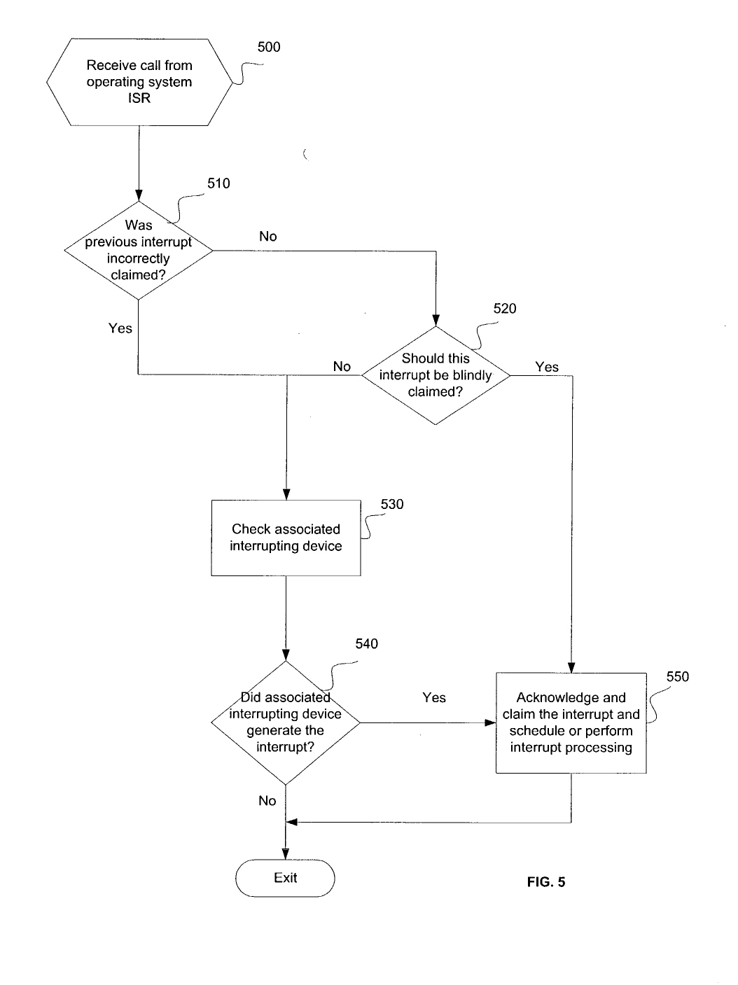

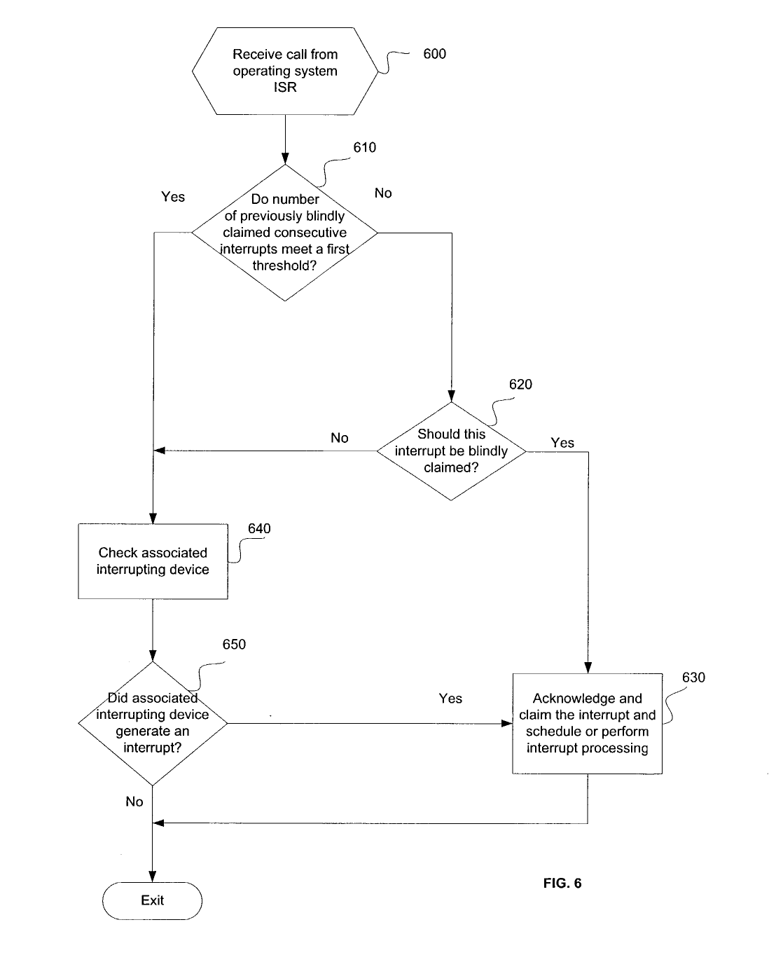

FIG. 5 illustrates logic implemented in a processing device ISR 114 to process an interrupt in accordance with certain embodiments of the invention. Embodiments of the invention selectively eliminate interrupting device accesses by allowing a processing device ISR 114 to claim an interrupt without actually determining whether an associated interrupting device generated the interrupt (i.e., “blindly” claim the interrupt). Then, the processing device ISR 114 can confirm whether it guessed correctly at a later time (e.g., in a deferred interrupt handling function 115). For example, if the processing device ISR 114 blindly claimed the interrupt, but the deferred interrupt handling function 115 has no interrupt events to process, then the processing device ISR 114 incorrectly claimed the interrupt. In certain embodiments, each processing device ISR includes a blindly claimed indicator (e.g., state variable 406 in FIG. 4) to indicate whether an interrupt was blindly claimed and a correctly claimed indicator (e.g., state variable 408 in FIG. 4) to indicate whether an interrupt was correctly claimed. In certain embodiments, the blindly claimed indicator 406 is set by the processing device ISR 114. In certain embodiments, the correctly claimed indicator 408 may be set by either the processing device ISR 114 or by an interrupt handling function 115 scheduled by the processing device ISR 114. In certain embodiments, to adjust for incorrectly blindly claiming an interrupt, the processing device ISR 114 does not blindly claim the next interrupt.

Control begins at block 500 with the processing device ISR 114 receiving a call from the operating system ISR 111 asking whether the processing device ISR's 114 associated interrupting device generated a particular interrupt. The processing device ISR 114 determines whether the previous (i.e., the last) interrupt was incorrectly claimed (block 510). The determination may be made, for example, by checking the blindly claimed indicator 406 and the correctly claimed indicator 408. If so, processing continues to block 530, otherwise, processing continues to block 520.

In block 520, the processing device ISR 114 determines whether this (i.e., new) interrupt should be claimed without checking whether the associated interrupting device generated this interrupt (i.e., whether the interrupt should be “blindly” claimed). The determination may be made based on one or more factors, such as a number of interrupts that were blindly claimed within a consecutive number of calls from the operating system ISR 111, a number of interrupts that were incorrectly claimed within a consecutive number of calls from the operating system ISR 111, or a number of interrupts that were claimed within a period of time. If this interrupt should be claimed, processing continues to block 550, otherwise, processing continues to block 530. In block 550, the processing device ISR 114 acknowledges and claims the interrupt and schedules (e.g., schedules a deferred interrupt handling function 115) or performs interrupt processing.

If the previous interrupt was incorrectly claimed, the processing device ISR 114 determines whether an associated interrupting device generated the interrupt. Thus, in block 530, the processing device ISR 114 checks the associated interrupting device (e.g., checks a status register). In block 540, the processing device ISR 114 determines whether the associated interrupting device generated the interrupt. If so, processing continues to block 550, otherwise, processing is done.

For some interrupting devices, the interrupt from the interrupting device would typically be correctly blindly claimed. High speed I/O controllers are one type of interrupting device for which this is true (e.g., a Gigabit Ethernet controller).

FIG. 6 illustrates logic implemented in a processing device ISR 114 to process an interrupt in accordance with certain alternative embodiments of the invention. In particular, to ensure that starvation of other processing devices in the chain of processing devices does not occur, consecutive blind interrupt claiming by a processing device ISR 114 does not exceed a first threshold (e.g., a reasonable percentage of processing device ISR 114 events). Control begins at block 600 with the processing device ISR 114 receiving a call from an operating system ISR asking whether the processing device ISR's 114 associated interrupting device generated a particular interrupt. In block 610, the processing device ISR 114 determines whether a number of previously blindly claimed interrupts meets a first threshold, regardless of whether the blindly claimed interrupts were correctly claimed. If so, processing continues to block 620, otherwise, processing continues to block 630.

In block 630, the processing device ISR 114 determines whether this interrupt should be claimed without checking whether the associated interrupting device generated this interrupt (i.e., whether the interrupt should be “blindly” claimed). If so, processing continues to block 630, otherwise, processing continues to block 640. In block 630, the processing device ISR 114 acknowledges and claims the interrupt and schedules (e.g., schedules a deferred interrupt handling function 115) or performs interrupt processing.

In block 640, the processing device ISR 114 checks the associated interrupting device (e.g., checks a status register). In block 650, the processing device ISR 114 determines whether the associated interrupting device generated the interrupt. If so, processing continues to block 630, otherwise, processing is done.

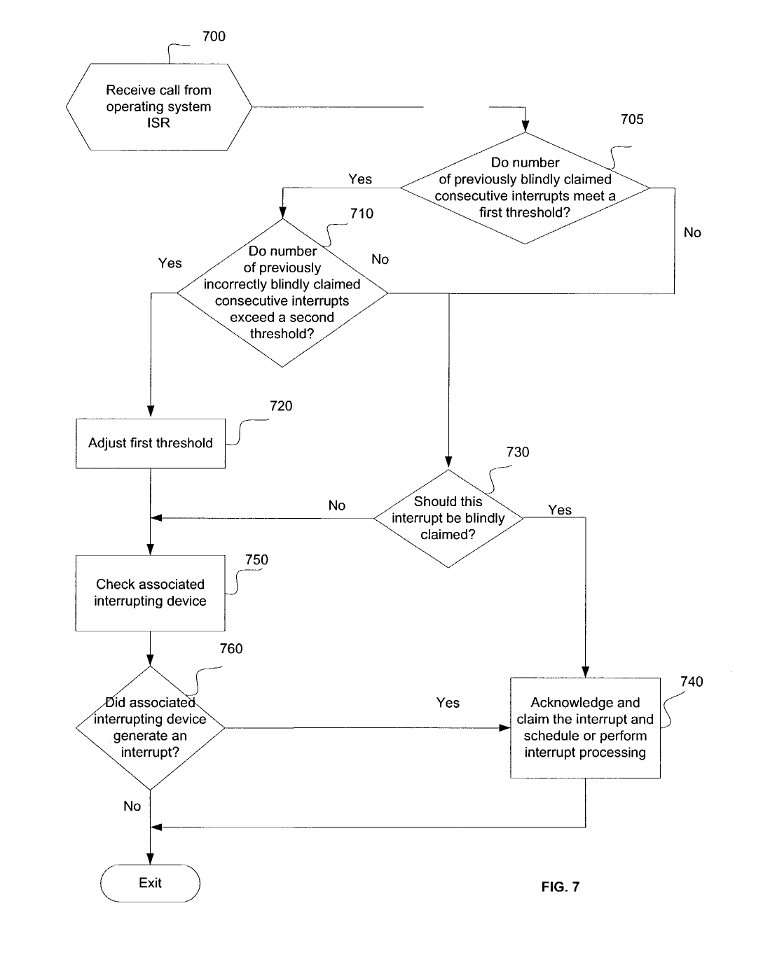

FIG. 7 illustrates logic implemented in a processing device ISR 114 to process an interrupt in accordance with certain alternative embodiments of the invention. In particular, the frequency of blind interrupt claiming (i.e., represented by the first threshold) is decreased when several (e.g., two or more) interrupts are incorrectly claimed on consecutive calls from the operating system ISR 111. Control begins at block 700 with the processing device ISR 114 receiving a call from an operating system ISR asking whether the processing device ISR's 114 associated interrupting device generated a particular interrupt. In block 705, the processing device ISR 114 determines whether a number of previously blindly claimed interrupts meets a first threshold, regardless of whether the blindly claimed interrupts were correctly claimed. If so, processing continues to block 710, otherwise, processing continues to block 730. In block 710, the processing device ISR 114 determines whether a number of previously incorrectly claimed interrupts exceeds a second threshold. If so, processing continues to block 720, otherwise, processing continues to block 730.

In block 720, the processing device ISR 114 adjusts the first threshold to reduce the frequency of blind interrupt claiming. For example, if the first threshold were set at five and the second threshold were set at six, if six multiple consecutive interrupts were incorrectly blindly claimed, the first threshold might be made smaller (e.g., set to three) so that in future only, for example, three consecutive interrupts would be blindly claimed. Optionally, the first threshold may be increased if multiple blindly claimed consecutive interrupts (e.g., exceeding a third threshold) were correctly claimed.

In block 730, the processing device ISR 114 determines whether this interrupt should be claimed without checking whether the associated interrupting device generated this interrupt (i.e., whether the interrupt should be “blindly” claimed). If so, processing continues to block 740, otherwise, processing continues to block 750. In block 740, the processing device ISR 114 acknowledges and claims the interrupt and schedules (e.g., schedules a deferred interrupt handling function 115) or performs interrupt processing.

In block 750, the processing device ISR 114 checks the associated interrupting device (e.g., checks a status register). In block 760, the processing device ISR 114 determines whether the associated interrupting device generated the interrupt. If so, processing continues to block 740, otherwise, processing is done.

In certain embodiments, an interrupting device asserting an interrupt to the interrupt controller 140 is an I/O controller 122, and the interrupt is to be processed by a device driver 118. As part of performing the interrupt processing, the device driver ISR 114A can determine whether the blind claiming of an interrupt was correct or not. For example, if the I/O controller 122 is a network media access controller (MAC), the device driver ISR 114A may check a receive queue and transmit completion queues of the I/O controller 122. If no data packets are waiting for processing and no other interrupt events have occurred, then the device driver ISR 114A determines that the interrupt was incorrectly claimed.

In summary, embodiments of the invention reduce the number of interrupting device hardware accesses that a processing device ISR 114 performs. This reduces the time spent in the processing device ISR function and improves overall system performance. With certain embodiments of the invention, the processing device ISR 114 selectively claims interrupts without verifying that an associated interrupting device was the generation source of the interrupt. This is done in a manner that allows interrupt sharing.

Additionally, embodiments of the invention reduce the overhead and corresponding execution time latency that occurs in the processing device ISR 114. Since embodiments of the invention reduce the overhead and execution of processing device ISR 114s, more of the CPU time is spent processing the interrupt events instead of waiting for overhead bus accesses to complete.

This technique is even more effective in multiprocessor systems. In multiprocessor-based systems, devices do not share interrupts (e.g., each device is generally assigned a unique interrupt vector), and so when a processing device ISR blindly claims an interrupt, the processing device ISR 114 is usually correct in assuming the interrupt as generated by an associated interrupting device (except in the case of spurious interrupts, which are rare in level-based interrupt embodiments).

Windows is a trademark of Microsoft Corporation.

### Additional Embodiment Details

The described techniques for maintaining information on network components may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, flash, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain logic operations were performed by the device driver 118. In alternative embodiments, these logic operations may be performed by another device.

In the described embodiments, the data packets were transferred over a network 116. In alternative embodiments, the data packets may be transferred to local storage, to a peripheral device, or to another device without being transferred over the network 116.

The illustrated logic of FIGS. 3, 5, 6, and 7 describe specific logic operations occurring in a particular order. In alternative embodiments, certain of the logic operations may be performed in a different order, modified or removed. Moreover, steps may be added to the above described logic and still conform to the described embodiments. Further, logic operations described herein may occur sequentially or certain logic operations may be processed in parallel, or logic operations described as performed by a single process may be performed by distributed processes.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for processing an interrupt, comprising:
receiving a new interrupt;
determining whether a previous interrupt was correctly claimed; and
if the previous interrupt was correctly claimed, determining whether to claim the new interrupt without determining whether an associated interrupting device generated the new interrupt.

2. The method of claim 1, further comprising:
if it is determined to claim the new interrupt without determining whether the associated interrupting device generated the new interrupt, claiming the new interrupt.

3. The method of claim 1, wherein determining whether to claim the interrupt is based on a number of consecutive interrupts that were previously incorrectly claimed.

4. The method of claim 1, wherein determining whether to claim the interrupt is based on a number of consecutive interrupts that were previously claimed without determining whether the associated interrupting device generated the consecutive interrupts.

5. The method of claim 1, further comprising:
if the previous interrupt was incorrectly claimed, determining whether an associated interrupting device generated the new interrupt; and
if the associated interrupting device generated the new interrupt, claiming the new interrupt.

6. A method for processing an interrupt, comprising:
receiving a new interrupt;
determining whether a number of previously claimed consecutive interrupts that were claimed without determining whether an associated interrupting device generated each of the consecutive interrupts meets a first threshold; and
if the first threshold is not met, determining whether to claim the new interrupt without determining whether an associated interrupting device generated the new interrupt.

7. The method of claim 1, further comprising:
if the first threshold is met, determining whether the associated interrupting device generated the new interrupt.

8. The method of claim 6, further comprising:
if the first threshold is met, determining whether a number of the previously claimed consecutive interrupts that were incorrectly claimed exceeds a second threshold; and
if the second threshold is exceeded, adjusting the first threshold.

9. A method for processing an interrupt, comprising:
receiving an interrupt; and
claiming the interrupt without determining whether an associated device generated the interrupt.

10. The method of claim 9, further comprising:
receiving a new interrupt;
determining whether a previous interrupt was correctly claimed; and
if the previous interrupt was correctly claimed, determining whether to claim the new interrupt without determining whether an associated interrupting device generated the new interrupt.

11. A system for processing an interrupt, comprising:
a processor;
memory coupled to the processor; and
at least one program executed by the processor in the memory to cause the processor to perform:
(i) receiving a new interrupt;
(ii) determining whether a previous interrupt was correctly claimed; and
(iii) if the previous interrupt was correctly claimed, determining whether to claim the new interrupt without determining whether an associated interrupting device generated the new interrupt.

12. The system of claim 11, wherein the at least one program further causes the processor to perform:
if the previous interrupt was incorrectly claimed, determining whether an associated interrupting device generated the new interrupt; and
if the associated interrupting device generated the new interrupt, claiming the new interrupt.

13. A system for processing an interrupt, comprising:
a processor;
memory coupled to the processor; and
at least one program executed by the processor in the memory to cause the processor to perform:
(i) receiving a new interrupt;
(ii) determining whether a number of previously claimed consecutive interrupts that were claimed without determining whether an associated interrupting device generated each of the consecutive interrupts meets a first threshold; and
(iii) if the first threshold is not met, determining whether to claim the new interrupt without determining whether an associated interrupting device generated the new interrupt.

14. The system of claim 13, wherein the at least one program further causes the processor to perform:
if the first threshold is met, determining whether the associated interrupting device generated the new interrupt.

15. The system of claim 13, wherein the at least one program further causes the processor to perform:
if the first threshold is met, determining whether a number of the previously claimed consecutive interrupts that were incorrectly claimed exceeds a second threshold; and
if the second threshold is exceeded, adjusting the first threshold.

16. A system for processing an interrupt, comprising:
a processor;
memory coupled to the processor; and
at least one program executed by the processor in the memory to cause the processor to perform:
(i) receiving an interrupt; and
(ii) claiming the interrupt without determining whether an associated device generated the interrupt.

17. A system for processing an interrupt, comprising:
an interrupting device;
a processing device; and
means at the processing device for:
(i) receiving a new interrupt;
(ii) determining whether a previous interrupt was correctly claimed; and
(iii) if the previous interrupt was correctly claimed, determining whether to claim the new interrupt without determining whether the interrupting device generated the new interrupt.

18. A system for processing an interrupt, comprising:
an interrupting device;
a processing device; and
means at the processing device for:
(i) receiving a new interrupt;
(ii) determining whether a number of previously claimed consecutive interrupts that were claimed without determining whether an associated interrupting device generated each of the consecutive interrupts meets a first threshold; and
(iii) if the first threshold is not met, determining whether to claim the new interrupt without determining whether an associated interrupting device generated the new interrupt.

19. A system for processing an interrupt, comprising:
an interrupting device;
a processing device; and
means at the processing device for:
(i) receiving an interrupt; and
(ii) claiming the interrupt without determining whether an associated device generated the interrupt.

20. An article of manufacture including a program for processing an interrupt, wherein the program causes operations to be performed, the operations comprising:
receiving a new interrupt;
determining whether a previous interrupt was correctly claimed; and
if the previous interrupt was correctly claimed, determining whether to claim the new interrupt without determining whether an associated interrupting device generated the new interrupt.

21. The article of manufacture of claim 20, the operations further comprising:
if the previous interrupt was incorrectly claimed, determining whether an associated interrupting device generated the new interrupt; and
if the associated interrupting device generated the new interrupt, claiming the new interrupt.

22. An article of manufacture including a program for processing an interrupt, wherein the program causes operations to be performed, the operations comprising:
receiving a new interrupt;
determining whether a number of previously claimed consecutive interrupts that were claimed without determining whether an associated interrupting device generated each of the consecutive interrupts meets a first threshold; and
if the first threshold is not met, determining whether to claim the new interrupt without determining whether an associated interrupting device generated the new interrupt.

23. The article of manufacture of claim 22, the operations further comprising:
if the first threshold is met, determining whether the associated interrupting device generated the new interrupt.

24. The article of manufacture of claim 22, the operations further comprising:
if the first threshold is met, determining whether a number of the previously claimed consecutive interrupts that were incorrectly claimed exceeds a second threshold; and
if the second threshold is exceeded, adjusting the first threshold.

25. An article of manufacture including a program for processing an interrupt, wherein the program causes operations to be performed, the operations comprising:
receiving an interrupt; and
claiming the interrupt without determining whether an associated device generated the interrupt.

26. An article of manufacture including an operating system and a device driver for processing an interrupt, wherein the operating system and device driver cause operations to be performed, the operations comprising:
receiving a new interrupt;
determining whether a previous interrupt was correctly claimed; and
if the previous interrupt was correctly claimed, determining whether to claim the new interrupt without determining whether an associated interrupting device generated the new interrupt.

27. An article of manufacture including an operating system and a device driver for processing an interrupt, wherein the operating system and device driver cause operations to be performed, the operations comprising:
receiving a new interrupt;
determining whether a number of previously claimed consecutive interrupts that were claimed without determining whether an associated interrupting device generated each of the consecutive interrupts meets a first threshold; and
if the first threshold is not met, determining whether to claim the new interrupt without determining whether an associated interrupting device generated the new interrupt.

28. An article of manufacture including an operating system and a device driver for processing an interrupt, wherein the operating system and device driver cause operations to be performed, the operations comprising:
receiving an interrupt; and
claiming the interrupt without determining whether an associated device generated the interrupt.
